(19) United States
(12) Patent Application Publication
(10) Pub. No.: US 2005/0174776 A1
(43) Pub. Date: Aug. 11, 2005

(54) Apparatus having a light of illumination of a sign

(76) Inventor: Peter Althaus, Zug (CH)

Correspondence Address: BIRCH STEWART KOLASCH & BIRCH, PO BOX 747, FALLS CHURCH, VA, 22040-0747, US

(21) Appl. No.: 10/775,220

(22) Filed: Feb. 11, 2004

(51) Int. Cl. F21S 9/03

(52) U.S. Cl. 362/276; 362/183

(57) ABSTRACT

A light (10, 11) of an apparatus for illumination of a sign (1), in particular of a traffic sign, is part of a unit (7, 8) which can be attached permanently to the existing sign and contains a power supply which is independent of the mains. In addition to the illumination of the sign, a further light (12) may also illuminate a surrounding area, for example areas of footpaths and roads.

### PRIOR ART

Many accidents on roads, in particular those involving pedestrians, take place during twilight, at night or in poor weather conditions. A significant number of the accidents are also caused by someone in a motor vehicle perceiving the risk, for example, someone in the roadway area, too late owing to poor light conditions, and no longer having sufficient time to carry out a braking or turning manoeuvre. Particularly outside urban areas, roads are often unilluminated, so that the risk of accidents such as these is particularly high there. However, even within built-up areas—and even on illuminated roads—shadows from buildings and abrupt changes from light to shadow can result in danger points.

For these reasons, marked pedestrian crossings, so-called zebra crossings, are marked by illuminated signs in poor lighting conditions, so that pedestrians can find them and road users are warned. Furthermore, the area of the pedestrian crossing is often also illuminated so that those in motor vehicles can see when someone is crossing the road. A normal solution is to install a sign which is in the form of a box in whose interior a light source (often a fluorescent lamp) which is fed from the mains provides illumination through two side surfaces of the box, which are in the form of translucent signs, while a further light source (often similar to a normal road lighting apparatus) which is fed from the mains illuminates the road area together with the pedestrian crossing.

One major disadvantage of this solution is that—particularly in remote locations, for example outside urban areas—the installation of a power supply is highly complex and therefore expensive, for which reason no illuminated board or pedestrian crossing illumination is often installed. A further disadvantage is that, with a conventional solution, the outer walls of the box are composed of a material (glass) which can be damaged by vandals using quite simple means (for example by throwing stones). Furthermore, in the case of the described conventional solution, care must be taken to ensure that the illuminated signs are out of range of people since their outer walls are so severely heated by the lights that are used that contact with them can cause burns.

Other road signs are also generally not illuminated outside urban areas owing to the high costs of supplying power from the mains. Signs such as those warning of wild animals crossing, the risk of skidding or bends are, however, particularly important during twilight, at night or in poor lighting conditions.

### DESCRIPTION OF THE INVENTION

The object of the invention is to improve road safety, in particular the safety of pedestrians when crossing roads, in poor lighting conditions.

The way in which the object is achieved is defined by the features of Claim 1. An apparatus having a light for illumination of signs is in the form of a unit, which can be permanently attached to the existing sign and has a power supply which is independent of the mains.

One important advantage of the invention is simple installation. Since it is independent of the mains, there is no need to install a power supply, thus avoiding a large proportion of the complexity of conventional solutions. The attachment to existing signs in its own right also ensures anchorage in the ground (or anywhere else) as well as positioning at a desired height, and these need not be carried out again. Furthermore, the configuration of the apparatus as a unit allows simple installation on normal existing signs, and this installation work can be carried out even by untrained personnel with minimum tools. The invention is expediently configured such that the illumination apparatus is self-cleaning, that is to say dirt deposited on it is in each case removed again by natural rainfall. To this end, the shape of the housing is on the one hand designed such that there are no angles or recesses in which water and dirt could accumulate. On the other hand, the housing can be provided with an anti-adhesion coating on its outer face, so that dirt cannot be deposited on it in the first place.

The invention is not restricted to being used for illumination of traffic signs. It is particularly suitable for information signs and advertising hoardings outside urban areas, which are intended to be seen in the evening or at night, that is to say for example for facilities which are visited at these times of day (public houses, discotheques, night clubs, etc.).

If possible, the mains-independent power supply is integrated in the unit which is attached to the sign. This means that no further attachment elements are required for the power supply and there is no need for any external cable connection from the power supply to the unit.

The illumination apparatus is advantageously supplied with energy by solar cells. During daylight periods, solar energy is absorbed, controlled by an automatic charger which is integrated in the control electronics, and is stored in rechargeable batteries. During darkness between the evening twilight and the morning twilight, and possibly in poor weather, for example during storms, the stored energy is emitted again by means of the lights that are installed. Compared to batteries, rechargeable batteries or fuel cells, which have to be replaced or replenished periodically, this solution is characterized in that it allows a long operating life (of up to several years) without any maintenance. In comparison to solutions such as wind generators, it has the advantage that sunlight is available in regular, predictable time periods.

In order to allow the illumination apparatus to be installed without any previous adaptation at all locations, it is advantageous for the solar cells to be arranged adjustably, so that they can be aligned such that they can convert the maximum amount of sunlight to electrical energy. A conventional, flat, rectangular solar panel is generally arranged such that it can be inclined about an axis which corresponds to a broad face or a longitudinal face of the panel. As an alternative to this, a ball joint can also be provided, which is fitted in the centre of the panel and allows optimum alignment irrespective of the positioning of the existing sign. Mechanically moving parts such as rotation shafts, hinges or ball joints are, however, susceptible to material fatigue, corrosion and destruction by vandalism. It may therefore be advantageous not to use elements such as these and, instead of this, to provide different embodiments of the illumination apparatus with solar cells fitted in different ways or else—preferably—an illumination apparatus with convex-curved solar cells, which can make use of sunlight that falls on it over a wide spatial angle.

The sign is advantageously illuminated by means of LED lights, which are characterized by lower power consumption and low thermal power. This allows a long operating time with a given amount of energy and, furthermore, it avoids the risk of burns being caused by touching the illuminated sign or the illumination apparatus. Other lights, for example economy fluorescent lights, may, of course, also be used. The lights are advantageously in the form of bars and are fitted parallel to one face of the sign (or tangentially in the case of a round sign), with their length corresponding to the side length of the sign (or its diameter). The lights are preferably offset somewhat from the plane of the sign, so that the sign can be illuminated uniformly by tilting their light beam slightly inwards, without this resulting in road users being dazzled.

A further illumination option is to fit an LED sheet to the sign to be illuminated. White light is introduced into this from a side edge by means of diodes and distributed by the sheet, striking the sign which is located underneath, and being emitted through the transparent sheet. This results in uniform illumination and avoids irritation caused by dazzling.

Traffic signs may be designed such that the actual sign is attached to a frame which completely surrounds it and is composed, for example, of steel tubes. In this case, it is advantageous for the illumination apparatus according to the invention to be designed such that it can be attached directly to the robust frame. In particular, this allows the sign to be replaced without the process being impeded by the illumination apparatus, and avoids parts on the edge of the sign being concealed by attachment elements of the illumination apparatus, particularly in the case of two-sided signs.

An L-shaped configuration of the apparatus according to the invention with a horizontal limb and a vertical limb offers the advantage that robust attachment can be achieved easily, for example with one attachment point for each limb with the most conventional sign shapes—for example round, rectangular or octagonal. If the sign to be illuminated or a frame which surrounds it has a rectangular (or octagonal shape), an L-shaped unit is preferably fitted such that the horizontal limb is located on the upper face of the signal or of the frame, so that the weight of the apparatus is borne by the sign, and such that attachment of the vertical limb fixes the orientation of the apparatus. Furthermore, an L-shaped configuration offers more space in the two limbs for accommodation of rechargeable batteries, and thus a longer operating period.

The aim is for the illumination apparatus to produce its effect in poor lighting conditions, in particular at night. Matching to weather conditions and the times of year is preferably achieved by using one or more light sensors. These ensure that the control electronics switch the apparatus on when the light intensity falling on it is below an (adjustable) threshold, and switch it off again when the light intensity is above a (likewise adjustable) threshold, in order to conserve energy reserves. In order to prevent the apparatus from being switched on and off excessively frequently, either the switching-off intensity is chosen to be slightly higher than the switching-on intensity (hysteresis), or the apparatus is switched off with a certain time delay once the corresponding light intensity has been exceeded. In addition, the light sensors can also be used to control the light power of the light: a low light power is sufficient to make the sign visible from a long distance at night, and this also prevents dazzling. During twilight or against a background lighting, on the other hand, a high light power is required in order to allow the signal to produce its warning effect.

Signs produce their effect, namely warning or informing, only when they are within someone's visual range. It is therefore advantageous to switch the lighting on only when proximity sensors determine that people (pedestrians, in cars etc.) are within an appropriate range. This means that the energy consumption is kept low. In the case of a sign which, for example, indicates a pedestrian crossing, the warning effect on those in motor vehicles is also greater. Specifically, this is because the proximity sensor reacts only to pedestrians and road users know that the lighting is switched on only when pedestrians are present. Furthermore, for example, a sign which is intended to warn against wild animals crossing may be illuminated only when wild animals which are approaching the road result in the apparatus being switched on by means of appropriately directed proximity sensors.

In the case of pedestrian crossings, an addition to the sign warning car drivers to be cautious and to be aware of pedestrians on the crossing, it is also useful to illuminate the crossing itself, particularly to ensure that pedestrians who are crossing the road can be seen. An illumination apparatus according to the invention might therefore also contain, in addition to the actual illumination for the sign, a light source which specifically illuminates parts of the surrounding area, in particular the pedestrian crossing. Further applications for additional surrounding area illumination may, for example, be to prevent wild animals from crossing a road when road users are approaching. In order to allow the surrounding area illumination to be matched to the actual situation, for example to the width of the road or to the distance between the sign with the installed apparatus according to the invention and the edge of the road, the aperture angle of the surrounding area light source as well as the preferred direction of its light beam may be adjustable.

The statements made with regard to the illumination of the sign also apply to the surrounding area illumination, in that LED light sources, in this case LED spotlights (LED spots) contribute to an optimum energy yield and minimize the amount of heat produced.

The use of light sensors which switch on the illumination of the surrounding area only during poor lighting conditions to control the surrounding area illumination likewise ensures a long illumination duration with the given amounts of energy. In the case of surrounding area illumination, as well, it is possible to show that the light intensity of the light can be matched to the circumstances, that is to say it can be reduced at night, for example, and can be increased in twilight and particularly in the case of background lighting.

Proximity sensors may be used to switch the surrounding area illumination on only when it is required, thus further minimizing the energy consumption. When illuminating pedestrian crossings, for example, illumination is required only when there are people in the area of the crossing. Furthermore, selective illumination has the advantage that road users on the road are warned to take particular care only when necessary. This avoids a familiary effect caused by a large number of warning signs, and as far as possible prevents night vision being adversely affected by dazzling effects. A time circuit can be used to ensure that the surrounding area illumination is switched off again after a certain time, after which no one else is detected in the area of the pedestrian crossing, so that it can be assumed that there is no longer anyone in the danger area.

Further advantageous embodiments and feature combinations of the invention will become evident from the following detailed description and from the totality of the patent claims.

### BRIEF DESCRIPTION OF THE DRAWINGS

In the drawings, which are used to explain the exemplary embodiment,

FIG. 1 shows an illumination module according to the invention and its installation on a frame for holding a sign;

FIG. 2 shows the configuration of the illumination module according to the invention, fitted to the frame, with an open horizontal limb;

FIG. 3 shows a cross section through an aluminium half-profile, from which the illumination module is mainly formed.

In principle, identical parts are provided with identical reference symbols in the figures.

### APPROACHES TO IMPLEMENTATION OF THE INVENTION

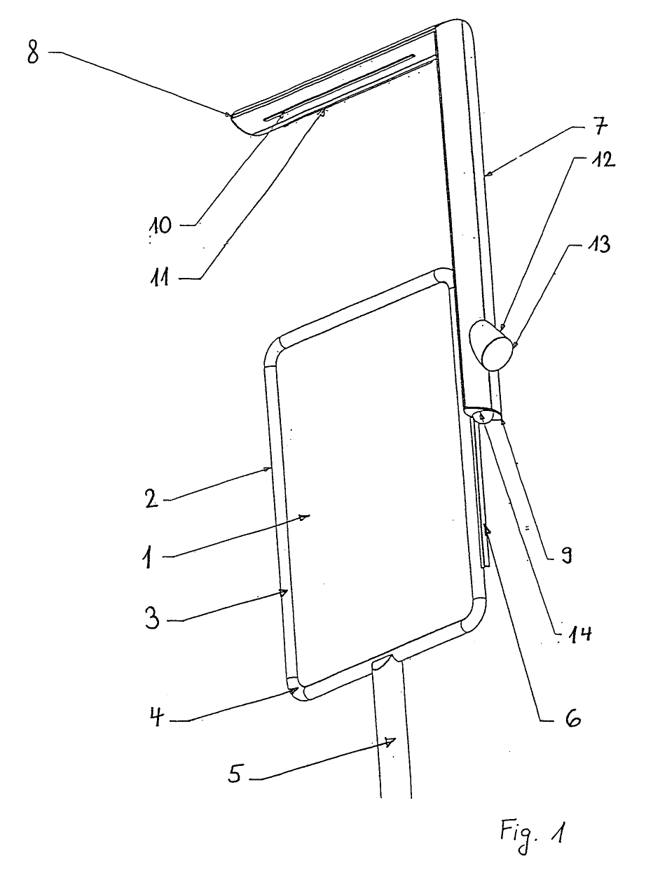

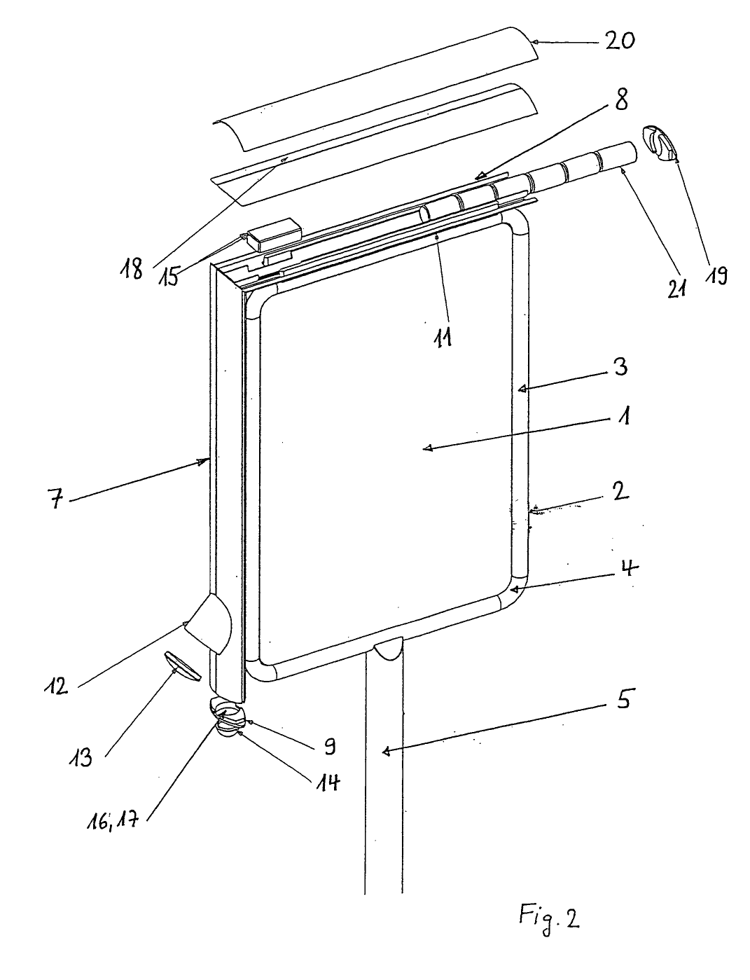

FIGS. 1 and 2 show an apparatus according to the invention for illumination of an existing rectangular sign 1, which is surrounded by a tubular frame 2. This tubular frame 2 is rectangular, corresponding to the shape of the sign, with its vertical extent being greater than its horizontal extent. It is formed from four straight frame tubes 3, which are each connected by means of short, rounded corner pieces 4, which are in the form of 90° curved tubes with the same cross section. The centre of the lower side tube of the tubular frame is welded to a vertical tube 5 with a larger cross section, which is anchored in the ground, and holds the tubular frame with the sign at the desired height. Depending on the purpose, a single sign 1 may be fitted on one side or else two signs on both sides, by riveted joints, by means of four perforated attachment brackets which are welded to the corner pieces 4 internally at the frame level.

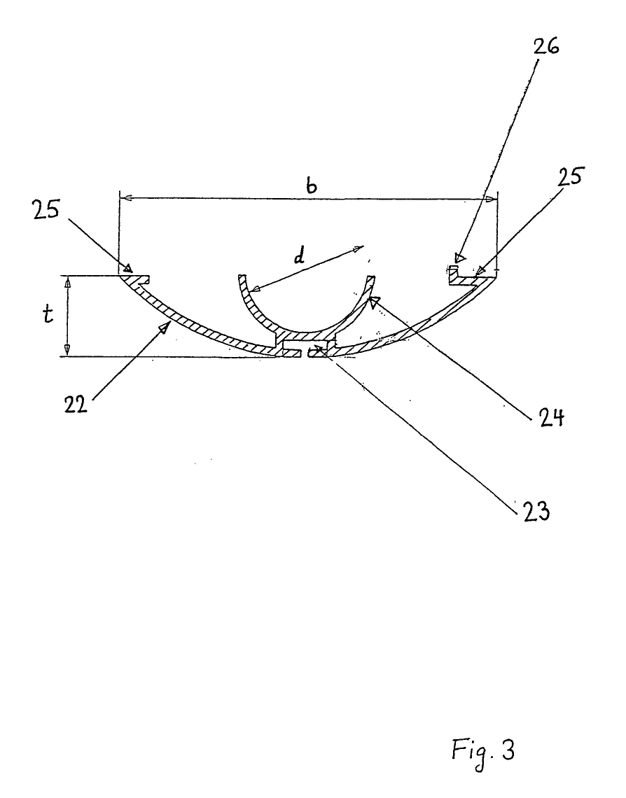

The apparatus for illumination of the sign is formed from aluminium half profiles 18, whose cross section is shown in FIG. 3. The outer face of the profile is convex and has uniform curvature, with the width b of the half profile being about 5 times greater than its depth t. The convex shape reduces deposits of dirt, snow or water and ensures self-cleaning by rainwater. The half profile has a T-shaped groove 23 on its outer face, which is formed by a slotted opening along the centre of the outer face of the profile, and by the inner profile 24. This has a semicircular cross section, so that it can hold the cylindrical rechargeable batteries 21. The internal diameter d of the inner profile is approximately ⅓ of the width b of the aluminium half profile. The external profile 22 is fitted at each of its ends with flat pieces 25 which point to the interior of the profile, and one of which is provided with a tab 26 at its inner end. This allows an accurate interlocking fit between the two half profiles, and thus a connection which is watertight and dust tight. The four half profiles are each chamfered at one of their ends, so that they can be connected as is shown in FIG. 2 to form an L-shaped unit, comprising a vertical limb 7 and a horizontal limb 8.

A rail 6 is attached to the tubular frame 2 for attachment of the unit. This may be done by screws which are fitted in the rail such that they are countersunk and are screwed into pre-drilled holes in the frame tube 3, if necessary using cavity screw fittings. Another option is to use a strip connection, for example tube flanges, which allow attachment without any permanent effect on the sign or its frame.

The groove of the vertical limb 7 is now pushed onto the rail 6 that is attached to the frame. Unauthorised removal of the unit by pushing out is made more difficult by a further screw connection or strip connection of the horizontal limb 8 to the upper tube of the tubular frame.

The horizontal limb 8 holds the control electronics 15 as well as rechargeable battery cells 21, and the vertical limb 7 holds further rechargeable battery cells 21, light and proximity sensors 16, 17 as well as the surrounding area illumination 12. At their outer ends, the limbs are closed by covers 9, 19 such that they are watertight and dust tight. The exemplary embodiment illustrated in FIGS. 1 and 2 is suitable for illumination of a two-sided sign or of two signs which are fitted to the two sides of the tubular frame. The horizontal limb 8 thus has two LED illumination bars 10 and 11 on its lower outer face, and these provide illumination from above of the signs 1 which are attached to the two sides of the tubular frame. An LED spotlight 12 is installed in the vertical limb, illuminates parts of the surrounding area, and is protected against the ingress of water, dust or foreign bodies by the spotlight lens 13. The illumination apparatus is thus generally fitted such that the vertical limb is located on the side of the sign facing the road. The light sensor 16 and the proximity sensor 17 pass through an opening in the lower profile cover 9 of the vertical limb, and are protected against external influences by a protective cover 14.

The energy that can be consumed is provided by solar cells 20 which cover the entire outer face of the upper half profile of the horizontal limb 8. Their shape corresponds to the convex-curved outer face of the aluminium half profile 18, and allows sunlight to be absorbed independently of the installation direction of the sign 1. The energy which is absorbed by the solar cells 20 is stored in the rechargeable battery cells 21, controlled by the automatic charger contained in the control electronics 15. These rechargeable battery cells 21 are distinguished by a low charging current so that they can be charged even when there is little solar radiation. When the light intensity as detected by the light sensor 16 falls below an adjustable lower light intensity, the control electronics 15 switch on the sign illumination 10, 11 and the surrounding area illumination 9 and, when the light intensity is above an adjustable upper threshold, switch the lights 10, 11, 12 off again (in which case different lower and upper limits may be defined for the sign and surrounding area illumination). The signals received from the proximity sensor 17 are likewise used to switch the lights 10, 11, 12 of the apparatus on and off. For example, the surrounding area illumination can be controlled such that it is switched on only when there are people in the area which is covered by the proximity sensor 17, and such that it is switched off again a certain time after the people have left the area that is covered. The illumination of the sign 10, 11 can be switched in synchronism with the surrounding area illumination, or can be switched just on the basis of the signals from the light sensor 14, that is to say by the prevailing light intensity.

The control electronics 15 are in the form of a module, which can be replaced easily as an entity in the event of malfunctions.

The invention is not restricted to the described embodiment. If the sign to be illuminated is on only one side or there is only a single sign in a tubular frame, then a single light source on the front face of the sign is sufficient to illuminate, that is to say, for example, there is only one LED bar 10. The surrounding area illumination 12 may be omitted, the light source may be some form of light source other than an LED light, for example an economy fluorescent light, or it may be designed such that its aperture angle and the direction of its light cone are adjustable. If no surrounding area illumination 12 is desired, the apparatus may be designed in the form of a bar, for example, by means of only two aluminium half profiles 18, by omitting either the horizontal or—preferably owing to the alignment of the solar cells—the vertical limb. In this case, although fewer rechargeable battery cells 21 can be accommodated in the apparatus, the lack of the surrounding area illumination also means that the energy requirement is in this case reduced.

The energy consumption can also be provided by solar cells with a different shape, for example flat or V-shaped solar cells, rather than by curved solar cells 20. These are advantageously arranged such that they can be aligned, for example by means of a ball joint. Solar cells may likewise be positioned remotely from the apparatus, for example in the form of an additional panel, which is attached to the apparatus, to the sign or to its frame, to the vertical tube or to a horizontal arm of the sign, or may be mounted on their own vertical tube. A different system may also be used for producing energy (batteries, fuel cells, wind generators), instead of solar cells.

Furthermore, the sign may be illuminated by an LED sheet which is fitted to the sign, rather than by means of LED illumination bars. This LED sheet is transparent and white light is introduced into the sheet from above by means of diodes, which light then strikes the sign which is located underneath it, and illuminates it.

The shape of the apparatus may be matched to the shape of the sign and the attachment of the sign, for example of a frame surrounding it. An existing sign can thus also be attached at the side by means of horizontal struts or from above by means of vertical struts, instead of by means of a vertical tube. In the case of sign shapes, such as rectangles, whose horizontal extent is greater than their vertical extent, the rail 6 may also be fitted to the upper face of the frame, and the groove 23 of the horizontal limb 8 may be pushed onto this rail. An L-shape apparatus with the described combination of a groove 23 and rail 6 may even be fitted to the lower face of a sign which, for example, is attached at the side to a horizontal strut or at the top to a vertical strut, thus illuminating it from underneath. In this case, of course, if solar cells are used for absorbing energy, their arrangement must be modified such that it is once again possible for them to absorb sunlight.

For signs which are not attached to a frame surrounding them, the illumination apparatus may also be attached in some other way, for example by means of clamping screws. Particularly for the illumination of signs such as these, it may likewise be expedient to design the apparatus such that it can be attached to the vertical tube 5, illuminating the sign from underneath. Finally, the housing of the apparatus may also be manufactured from plastic instead of aluminium.

In summary, it can be stated that the invention allows the existing signs to be illuminated independently of the mains by simple retrofitting process.

1. Apparatus having a light for illumination of a sign, with the light being part of a unit which can be attached permanently to the existing sign, and with the apparatus having a power supply which is independent of the mains.

2. Apparatus according to claim 1, with the power supply which is independent of the mains being contained in the unit.

3. Apparatus according to claim 2, with solar cells (20) and rechargeable batteries (21) being provided in order to absorb and to store the necessary electrical energy.

4. Apparatus according to claim 3, with the solar cells (20) being arranged adjustably.

5. Apparatus according to claim 1, with one or more LED lights (10, 11) or an LED sheet which is fitted to the sign being provided in order to illuminate the sign.

6. Apparatus according to claim 1, also having attachment elements for attachment to a frame (2) which surrounds the sign to be illuminated.

7. Apparatus according to claim 1, with the unit being L-shaped.

8. Apparatus according to claim 1, furthermore having light sensors (16) for controlling the illumination of the sign.

9. Apparatus according to claim 1, furthermore having one or more proximity sensors (17) and/or an adjustable time circuit for switching the illumination of the sign on and off.

10. Apparatus according to claim 1, with the apparatus also having a surrounding area illumination for illumination of a surrounding area, in particular areas of footpaths and roads, in addition to the illumination of the sign, in which case the aperture angle and desired direction of a light cone from the surrounding area illumination (12) can be adjusted.

11. Apparatus according to claim 10, with LED spotlights (12) being provided in order to illuminate the surrounding area.

12. Apparatus according to one of claims 10, furthermore having light sensors (16) for controlling the surrounding area illumination.

13. Apparatus according to claim 10, furthermore having proximity sensors (17) and/or an adjustable time circuit for switching the surrounding area illumination on and off.
